(19) United States
(12) Patent Application Publication
(10) Pub. No.: US 2026/0129550 A1
(43) Pub. Date: May 7, 2026

(54) APPARATUS AND METHOD FOR SRv6 TRANSPORT NETWORK INTEGRATION IN WIRELESS COMMUNICATION SYSTEM

(71) Applicant: ELECTRONICS AND TELECOMMUNICATIONS RESEARCH INSTITUTE, Daejeon (KR)

(72) Inventors: Kyung Soo KIM, Daejeon (KR); Yoo Hwa KANG, Daejeon (KR); Nam Seok KO, Daejeon (KR); Seung Han CHOI, Daejeon (KR)

(73) Assignee: ELECTRONICS AND TELECOMMUNICATIONS RESEARCH INSTITUTE, Daejeon (KR)

(21) Appl. No.: 19/365,685

(22) Filed: Oct. 22, 2025

(30) Foreign Application Priority Data
Sep. 24, 2025 (KR) 10-2025-0137788
Nov. 5, 2024 (KR) 10-2024-0154922

(51) Int. Cl. H04W 40/14; H04L 45/02; H04L 45/12; H04W 40/22

(52) U.S. Cl. CPC H04W 40/14; H04L 45/02; H04L 45/123; H04W 40/22

(57) ABSTRACT

The present disclosure relates generally to wireless communication systems, and more specifically to an apparatus and method for integrating a core network with a Segment Routing IPv6-based transport network in a wireless communication system. A method of operating a Unified Transport Network Controller according to an embodiment of the present disclosure includes receiving segment routing node information and link information from a transport network controller, configuring a transport network topology based on the received segment routing node information and link information, calculating an optimal path according to service requirements based on the configured topology to generate a segment identifier list, and delivering the generated segment identifier list to a user plane function and radio access network through a session management function.

### CROSS REFERENCE TO RELATED APPLICATION

This application claims priority to Korean Patent Application No. 10-2024-0154922, filed on November 5, 2024, and Korean Patent Application No. 10-2025-0137788, filed on September 24, 2025, the entire contents of which are hereby incorporated by reference.

### BACKGROUND

### TECHNICAL FIELD

The present disclosure relates generally to wireless communication systems, and more specifically to an apparatus and method for integrating a core network with a Segment Routing IPv6 (SRv6) based transport network in a wireless communication system.

### DESCRIPTION OF THE RELATED ART

One important characteristic to note in the evolution of communication networks is that core networks and transport networks have been managed separately for a long time. This separation management approach has enhanced specialization in each domain and enabled independent development. While this has promoted technological innovation and optimization in each area, it has also brought certain limitations to the integrated operation and optimization of the entire network.

Traditionally, core networks have been directly managed by mobile network operators, responsible for subscriber management, session control, and mobility management. Core networks have evolved through generations, starting from circuit-switched systems in 2G and evolving through 3G and 4G to become packet-based all-IP networks. In contrast, transport networks are typically managed by separate teams or sometimes by different operators, focusing primarily on efficient data packet transmission.

Recent 5G networks have introduced revolutionary structural changes compared to previous generations of mobile networks. 5G networks consist primarily of Radio Access Networks (RAN) and core networks. The main components of 5G core networks include Access and Mobility Management Function (AMF), Session Management Function (SMF), and User Plane Function (UPF).

Currently in 5G networks, GPRS Tunneling Protocol (GTP) is used as the core protocol for transmitting user data within the core network. In terms of transport network technology, in addition to the widely used Multi-Protocol Label Switching (MPLS) technology, Segment Routing (SR) technology has recently gained attention. In particular, SRv6, which is the IPv6-based implementation of SR, has the potential to further improve scalability and flexibility in large-scale networks.

However, in the current 5G network architecture, core networks and transport networks are managed separately, leading to several technical limitations. The separation between core and transport networks limits consistent Quality of Service (QoS) policy application, making end-to-end service quality management difficult. Additionally, independent resource management in each domain limits efficient resource allocation and utilization at the overall network level. In terms of network slicing, it is difficult to consistently extend slices created in the core network to the transport network, restricting the implementation of true end-to-end slicing.

### SUMMARY

Based on the discussion above, the present disclosure provides an apparatus and method for effective integration of a core network and an SRv6-based transport network in a wireless communication system.

Further, the present disclosure provides an apparatus and method for enabling efficient utilization of network resources and consistent QoS policy application through transport network interworking functions in a wireless communication system.

Additionally, the present disclosure provides an apparatus and method for supporting end-to-end network slicing and real-time traffic path optimization through extension of existing 3GPP interfaces in a wireless communication system.

According to various embodiments of the present disclosure, a Unified Transport Network Controller (UTNC) for integrating a core network and a Segment Routing IPv6 (SRv6) based transport network in a wireless communication system receives SR node information and link information from a Transport Network Controller (TNC), configures a transport network topology based on the received SR node information and link information, calculates an optimal path according to service requirements based on the configured topology to generate a Segment Identifier (SID) list, and delivers the generated SID list to a User Plane Function (UPF) and Radio Access Network (RAN) through a Session Management Function (SMF).

According to various embodiments of the present disclosure, a UTN Application Function (UTN AF) for integrating a core network and an SRv6-based transport network in a wireless communication system receives SR node information and link information from a TNC, configures a transport network topology based on the received SR node information and link information, calculates an optimal path according to service requirements based on the configured topology to generate a SID list, delivers the generated SID list to a Policy Control Function (PCF) as policy information, and delivers policy rules generated by the PCF based on the policy information to UPF and RAN through SMF.

According to various embodiments of the present disclosure, a UTNC for integrating a core network and an SRv6-based transport network in a wireless communication system comprises a transceiver and a processor operably connected to the transceiver, wherein the processor is configured to receive SR node information and link information from a TNC, configure a transport network topology based on the received SR node information and link information, calculate an optimal path according to service requirements based on the configured topology to generate a SID list, and deliver the generated SID list to UPF and RAN through SMF.

According to various embodiments of the present disclosure, a UTN AF for integrating a core network and an SRv6-based transport network in a wireless communication system comprises a transceiver and a processor operably connected to the transceiver, wherein the processor is configured to receive SR node information and link information from a TNC, configure a transport network topology based on the received SR node information and link information, calculate an optimal path according to service requirements based on the configured topology to generate a SID list, deliver the generated SID list to PCF as policy information, and deliver policy rules generated by the PCF based on the policy information to UPF and RAN through SMF.

The apparatus and method according to various embodiments of the present disclosure enable resolving limitations in QoS policy application due to separated management structures by introducing transport network interworking functions to the core network.

Additionally, the apparatus and method according to various embodiments of the present disclosure enable efficient resource allocation and utilization at the overall network level through integration with SRv6-based transport networks, effectively meeting various service requirements demanded in next-generation networks.

The effects obtainable from the present disclosure are not limited to the above-mentioned effects, and other effects not mentioned will be clearly understood by those skilled in the art to which the present disclosure belongs from the following description.

### BRIEF DESCRIPTION OF THE DRAWINGS

FIG. 1 illustrates a service-based architecture of a wireless communication system according to various embodiments of the present disclosure.

FIG. 2 illustrates a structure of an SRv6-based transport network and controller according to various embodiments of the present disclosure.

FIG. 3 illustrates a UTNC-based core network and trusted SRv6 transport network interworking structure according to an embodiment of the present disclosure.

FIG. 4 illustrates a UTNC-based core network and untrusted SRv6 transport network interworking structure according to an embodiment of the present disclosure.

FIG. 5 illustrates an internal operation procedure of a Unified Transport Network Controller (UTNC) according to an embodiment of the present disclosure.

FIG. 6 illustrates a UTNC-based core network and trusted SRv6 transport network interworking procedure according to an embodiment of the present disclosure.

FIG. 7 illustrates a UTNC-based core network and untrusted SRv6 transport network interworking procedure according to an embodiment of the present disclosure.

FIG. 8a illustrates a TrafficInfluSub data type definition including SR information according to an embodiment of the present disclosure.

FIG. 8b illustrates a TrafficInfluSubPatch data type definition including SR information according to an embodiment of the present disclosure.

FIG. 9 illustrates SID information delivery through the N4 interface between SMF and UPF according to an embodiment of the present disclosure.

FIG. 10a illustrates an Nsmf _ PDUSession _ CreateSMContext procedure including SR information according to an embodiment of the present disclosure.

FIG. 10b illustrates an Nsmf _ PDUSession _ SMContextStatusNotify procedure including SR information according to an embodiment of the present disclosure.

FIG. 11 illustrates SID information delivery from AMF to RAN through the N2 interface according to an embodiment of the present disclosure.

FIG. 12 illustrates a core network and trusted SRv6 transport network interworking structure through UTN AF according to an embodiment of the present disclosure.

FIG. 13 illustrates a core network and untrusted SRv6 transport network interworking structure through UTN AF according to an embodiment of the present disclosure.

FIG. 14 illustrates a core network and trusted SRv6 transport network interworking procedure through UTN AF according to an embodiment of the present disclosure.

FIG. 15 illustrates a core network and untrusted SRv6 transport network interworking procedure through UTN AF according to an embodiment of the present disclosure.

FIG. 16a illustrates PolicyAuthorization Create / Update API parameter extension according to an embodiment of the present disclosure.

FIG. 16b illustrates an AfRoutingRequirement data type definition including SR information according to an embodiment of the present disclosure.

FIG. 17a illustrates a policy reply including SR rule during SMF session establishment/update according to an embodiment of the present disclosure.

FIG. 17b illustrates a policy notification when PCF creates/updates SR rule according to an embodiment of the present disclosure.

FIG. 18 illustrates a flowchart of a UTNC-based method according to an embodiment of the present disclosure.

FIG. 19 illustrates a flowchart of a UTN AF-based method according to an embodiment of the present disclosure.

FIG. 20 illustrates a device configuration diagram according to an embodiment of the present disclosure.

### DETAIL DESCRIPTION

The terms used in the present disclosure are merely used to describe particular embodiments and may not be intended to limit the scope of other embodiments. Singular expressions may include plural expressions unless the context clearly indicates otherwise. Technical or scientific terms used herein may have the same meanings as commonly understood by one of ordinary skill in the art described in the present disclosure. Terms defined in general dictionaries among the terms used in the present disclosure may be interpreted as having the same or similar meanings as those in the context of the related art, and unless explicitly defined in the present disclosure, they are not interpreted in ideal or excessively formal meanings. In some cases, even terms defined in the present disclosure cannot be interpreted to exclude embodiments of the present disclosure.

In various embodiments of the present disclosure described below, hardware approaches are described as examples. However, since various embodiments of the present disclosure include technologies using both hardware and software, various embodiments of the present disclosure do not exclude software-based approaches.

Furthermore, in the detailed description and claims of the present disclosure, "at least one of A, B, and C" may mean "only A", "only B", "only C", or "any combination of A, B, and C". Also, "at least one of A, B, or C" or "at least one of A, B, and/or C" may mean "at least one of A, B, and C".

Hereinafter, the present disclosure relates to an apparatus and method for SRv6 transport network integration in a wireless communication system. Specifically, the present disclosure describes technology for effectively integrating a core network and an SRv6-based transport network in a wireless communication system to enable efficient utilization of network resources and flexible service provision.

Terms referring to signals, terms referring to channels, terms referring to control information, terms referring to network entities, and terms referring to device components used in the following description are exemplified for convenience of description. Therefore, the present disclosure is not limited to the terms described below, and other terms having equivalent technical meanings may be used.

Furthermore, although the present disclosure describes various embodiments using terms used in some communication standards (e.g., 3rd Generation Partnership Project (3GPP)), this is merely an example for description. Various embodiments of the present disclosure can be easily modified and applied to other communication systems.

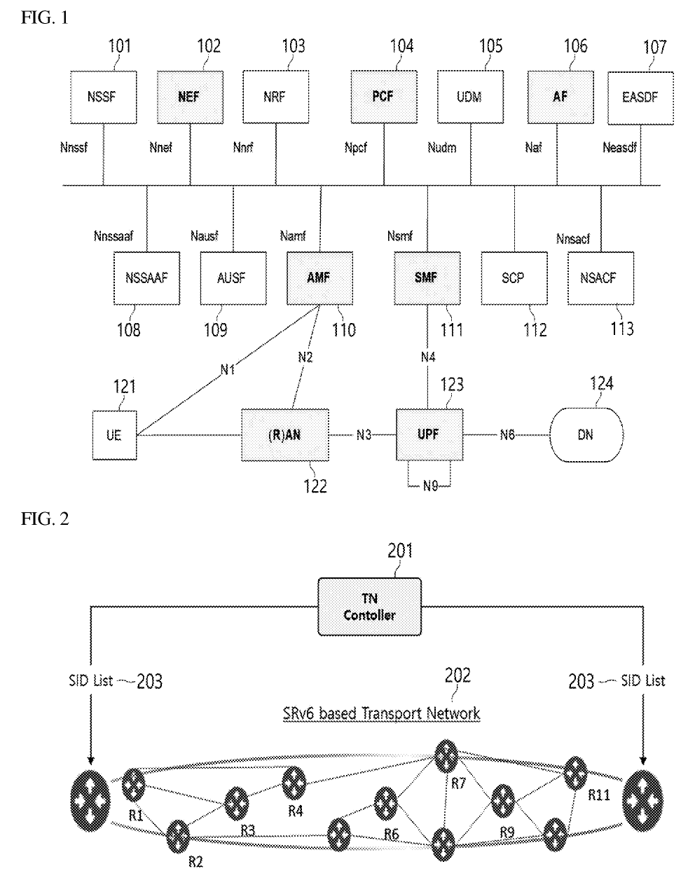

FIG. 1 illustrates a service-based architecture of a wireless communication system according to various embodiments of the present disclosure. FIG. 1 visually shows the interconnection relationships between major components of a 5G network.

Network functions include Network Slice Selection Function (101), Network Exposure Function (102), Network Repository Function (103), Policy Control Function (104), Unified Data Management (105), Application Function (106), and Edge Application Server Discovery Function (107).

Within the control plane are located Network Slice Specific Authentication and Authorization Function (108), Authentication Server Function (109), Access and Mobility Management Function (110), Session Management Function (111), Service Communication Proxy (112), and Network Slice Admission Control Function (113). As shown in the figure, network functions in the control plane are connected to each other through service-based interfaces named Nnf_, which is a key feature of the service-based architecture structure.

Meanwhile, connections between the control plane and other network elements (RAN, UPF) are made through separate N2 and N4 interfaces. This structure enables flexible communication within the control plane and efficient interworking with external systems.

User Equipment (121) connects to AMF (110) through the N1 interface, and Radio Access Network (122) connects to AMF (110) through the N2 interface and to User Plane Function (123) through the N3 interface. UPF (123) connects to SMF (111) through the N4 interface, to Data Network (124) through the N6 interface, and to other UPFs through the N9 interface.

Additionally, NEF (102) provides secure communication between external applications and the 5G core network. NEF (102) exposes 5G network capabilities to external systems through Northbound APIs and exchanges necessary information and services. This Northbound API is an important interface that allows external application developers to utilize 5G network functions.

The current 5G system architecture defines the main functions of the core network but does not explicitly include direct interworking functions with transport networks. Key 5G features such as network slicing, service-based architecture, and control and user plane separation are implemented through this architecture.

The Traffic Influence API of NEF (102) provides an interface that allows external application functions to influence traffic routing. Through this API, application functions can manage traffic influence subscriptions using various HTTP methods. To create a new traffic influence subscription, the application function sends an HTTP POST message to the "Traffic Influence Subscription" resource, with the request body containing the TrafficInfluSub data structure.

To update an existing traffic influence subscription, the application function sends an HTTP PUT message to the "Individual Traffic Influence Subscription" resource. When modifying only some parameters of a subscription, an HTTP PATCH message is used, with the request body containing the TrafficInfluSubPatch data structure. When NEF (102) receives such HTTP requests from application functions, it first verifies the application function's authorization.

The Policy Authorization API of PCF (104) authenticates requests from network function service consumers (primarily application functions), communicates with session management policy control services as needed to determine and install policies based on provided information, and provides various functions related to traffic control. Initial provisioning of service information can convey application traffic characteristics and requirements to PCF (104), and initial provisioning of traffic routing information can set routing requirements for specific application traffic.

One of the main parameters used in the Policy Authorization API is the AppSessionContextReqData type structure. The afRoutReq parameter within this structure is related to traffic routing influence and includes the AfRoutingRequirement type. The routeToLocs parameter within the AfRoutingRequirement type uses the RouteToLocation type. This RouteToLocation type has the same structure as the trafficRoutes provided by NEF (102), enabling consistent traffic routing information exchange between PCF (104) and NEF (102).

The interworking process between PCF (104) and SMF (111) mainly focuses on PDU session establishment and delivery of policy and charging control rules. During PDU session establishment, when a session establishment request occurs from user equipment, SMF (111) requests a policy decision from PCF (104). This request, as part of the session management policy control service, provides PCF (104) with information such as session information, QoS requirements, and user identifiers.

PCF (104) generates policy and charging control rules based on this information, considering network policies, subscriber profiles, and input from application functions when necessary. Policy and charging control rules include instructions regarding traffic control and QoS application. The generated policy and charging control rules are delivered from PCF (104) to SMF (111).

The N11 interface between SMF (111) and AMF (110) is defined as a service-based interface for PDU session management. SMF (111) provides PDU session services, which include various service operations managing PDU session creation, modification, and release. SMF (111) determines policies for PDU sessions based on information received through these service operations and delivers them to UPF (123) for actual user traffic processing.

Additionally, interworking with RAN is achieved through AMF (110), enabling configuration and management of radio resources. The PDU session service uses notification services to actively deliver information from SMF (111) to AMF (110) along with initial creation and update requests.

The N4 interface between SMF (111) and UPF (123) uses Packet Forwarding Control Protocol. Packet Forwarding Control Protocol is a protocol for the control plane (SMF) to control packet processing operations of the user plane (UPF). The main functions of Packet Forwarding Control Protocol are to configure and manage packet detection rules, forwarding action rules, and QoS enforcement rules for PDU sessions.

Packet detection rules define rules for identifying specific packet flows, forwarding action rules specify forwarding actions for detected packets, and QoS enforcement rules handle the application of QoS parameters for specific flows. SMF (111) controls UPF (123) operations through procedures such as Packet Forwarding Control Protocol session establishment, modification, and deletion.

The N2 interface between AMF (110) and RAN (122) uses NG Application Protocol. NG Application Protocol is responsible for signaling between AMF (110) and RAN (122) in the control plane. One of the main functions of NG Application Protocol is PDU session management.

Regarding PDU sessions, NG Application Protocol provides procedures such as PDU Session Resource Setup, PDU Session Resource Modify, and PDU Session Resource Release. The PDU Session Resource Setup procedure is used to set up new PDU session resources in RAN (122), and the PDU Session Resource Modify procedure is used to modify existing PDU session resources.

These procedures are used for AMF (110) to deliver session management information received from SMF (111) to RAN (122) and to coordinate QoS flow setup and radio resource allocation. In each procedure, AMF (110) sends PDU Session Resource Setup/Modify Request messages containing PDU session QoS information, security context, and transport information to RAN (122), and RAN (122) responds with PDU Session Resource Setup/Modify Response messages.

FIG. 2 illustrates the basic structure of an SRv6-based transport network and controller according to various embodiments of the present disclosure. The structure in FIG. 2 is based on SRv6 technology. Network (202) consists of multiple SRv6-enabled nodes such as R1, R2, R3, R4, R6, R7, R9, and R11, which are interconnected to form various paths.

TN Controller (201) is positioned at the top of the network to control the entire network. The TN Controller (201) in the present invention applies the concept of an SDN controller and can be any system that manages an SRv6 transport network. The main roles of TN Controller (201) include segment identifier configuration and management, network programming, and policy management for the transport network.

TN Controller (201) monitors the overall state of the network and can dynamically change network configuration as needed. The present invention aims to interwork with such SRv6-based transport networks. In particular, TN Controller (201) is utilized as the target for external transport network interworking for effective integration between core networks and SRv6-based transport networks.

SID list (203) provides path information at both ends of the network, enabling segment routing-based path control.

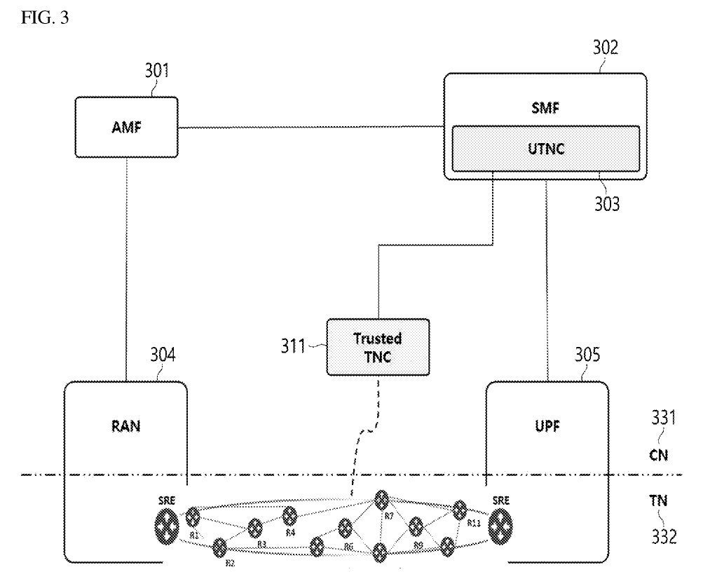

FIG. 3 illustrates an interworking structure between a core network and a trusted SRv6-based transport network through UTNC performing transport network interworking functions in the core network according to an embodiment of the present disclosure. UTNC (303) is a logical function of the control plane in core network (331) that can operate as a separate independent function, be deployed as an extension function of SMF (302), or be co-located with SMF (302). When UTNC is implemented as an extension function of SMF, information exchange between the two functions can be performed through internal function calls or predefined APIs. For example, when UTNC completes optimal path calculation, it can call a function like update_path(session_id, sid_list) that passes the SID list as a parameter to the PDU session management logic within SMF.

TNC (311) primarily manages information about SR nodes in the SRv6-based transport network and provides SRv6 network node information to UTNC (303). UTNC (303) performs transport network topology configuration, optimal path configuration per service, and SID information distribution to the data plane based on SR node and link information collected from TNC (311).

TNC (311) is a trusted TNC with reliability, typically applicable when the operators of the core network and transport network are the same. In this case, since the communication network operator and transport network operator are the same, complex security measures may not be necessary. The interface used can basically be defined as a RESTful API-based interface, or commonly used interfaces such as IETF YANG model-based Netconf/Restconf can be defined and used.

In the core network (331) area, AMF (301), SMF (302), RAN (304), and UPF (305) are located, with UTNC (303) implemented within SMF (302). In the transport network (332) area, trusted TNC (311) is located to manage the entire SRv6-based transport network. Within transport network (332), SR nodes such as R1, R2, R3, R4, R6, R7, R9, and R11 are deployed and interconnected to form various SR paths.

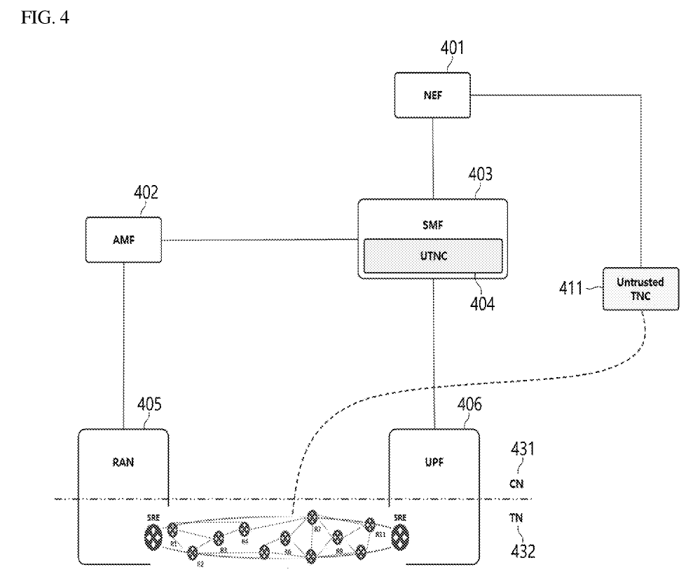

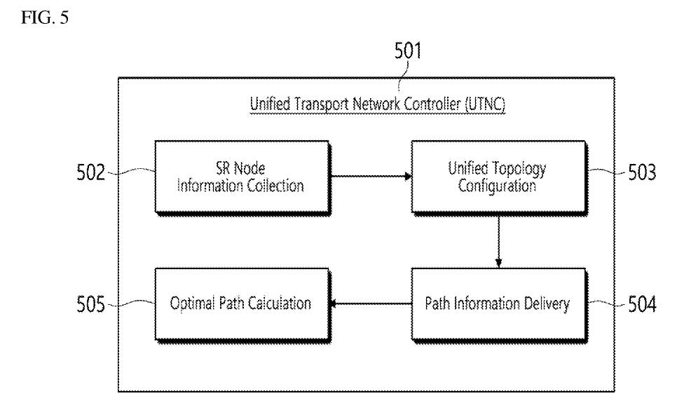

FIG. 4 illustrates an interworking method between a core network and a 3rd party transport network through UTNC performing transport network interworking functions in the core network according to an embodiment of the present disclosure. As in FIG. 3, UTNC (404) is a logical function of the core network that can operate as a separate independent function or be deployed as an extension function of SMF (403).

In FIG. 4, TNC (411) is an untrusted TNC, representing an SRv6 transport network operated by a 3rd party operator different from the communication network operator. Interworking with untrusted TNC (411) requires access to the core network through NEF (401) after appropriate authentication as defined by 3GPP.

TNC (411) communicates with the core network using NEF's (401) Traffic Influence API interface. The present disclosure defines extended parameters in this API to enable delivery of SR node and link information. This allows UTNC (404) to obtain topology information of the 3rd party transport network and make optimal routing decisions based on it.

This structure enables efficient network resource utilization and service optimization even when core network and transport network operators are different, and can be applied in the same way to the N6 section between UPF (406) operating as PSA and DN.

In the core network (431) area, NEF (401), AMF (402), SMF (403), RAN (405), and UPF (406) are located, with UTNC (404) implemented within SMF (403). In the transport network (432) area, untrusted TNC (411) is located to manage the SRv6-based transport network operated by a 3rd party operator.

Within transport network (432), SR nodes such as R1, R2, R3, R4, R6, R7, R9, and R11 are deployed and interconnected to form various SR paths. The interworking between NEF (401) and untrusted TNC (411) is shown with a dotted line, indicating a security-enhanced 3GPP standard-based interworking method.

FIG. 4 illustrates an interworking method between a core network and a 3rd party transport network through UTNC performing transport network interworking functions in the core network according to an embodiment of the present disclosure. As in FIG. 3, UTNC (404) is a logical function of the core network that can operate as a separate independent function or be deployed as an extension function of SMF (403).

In FIG. 4, TNC (411) is an untrusted TNC, representing an SRv6 transport network operated by a 3rd party operator different from the communication network operator. Interworking with untrusted TNC (411) requires access to the core network through NEF (401) after appropriate authentication as defined by 3GPP.

TNC (411) communicates with the core network using NEF's (401) Traffic Influence API interface. The present disclosure defines extended parameters in this API to enable delivery of SR node and link information. This allows UTNC (404) to obtain topology information of the 3rd party transport network and make optimal routing decisions based on it.

This structure enables efficient network resource utilization and service optimization even when core network and transport network operators are different, and can be applied in the same way to the N6 section between UPF (406) operating as PSA and DN.

In the core network (431) area, NEF (401), AMF (402), SMF (403), RAN (405), and UPF (406) are located, with UTNC (404) implemented within SMF (403). In the transport network (432) area, untrusted TNC (411) is located to manage the SRv6-based transport network operated by a 3rd party operator.

Within transport network (432), SR nodes such as R1, R2, R3, R4, R6, R7, R9, and R11 are deployed and interconnected to form various SR paths. The interworking between NEF (401) and untrusted TNC (411) is shown with a dotted line, indicating a security-enhanced 3GPP standard-based interworking method.

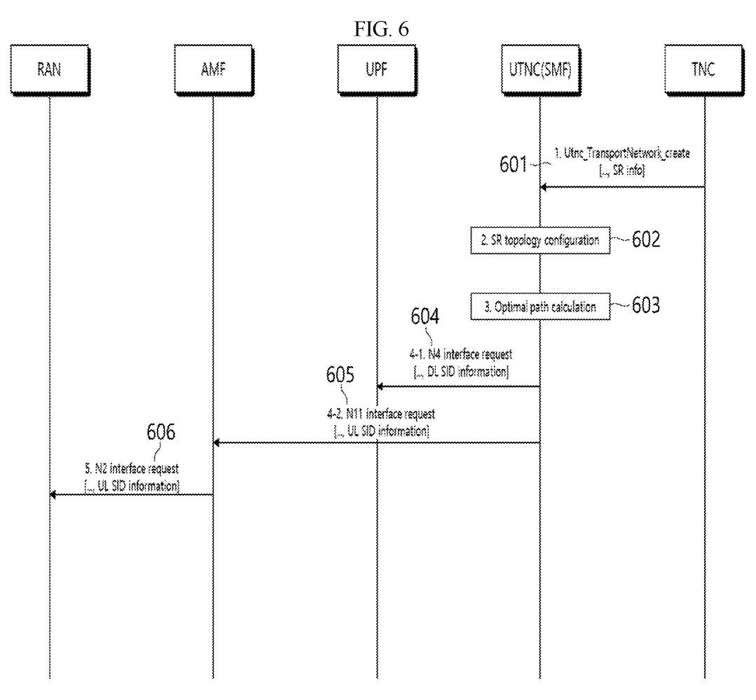

FIG. 6 illustrates a UTNC-based core network and trusted SRv6 transport network interworking procedure according to an embodiment of the present disclosure. This procedure is an interworking method with trusted TNC, performed through direct information exchange between TNC and UTNC.

TNC directly delivers SR node and link information to UTNC (601). TNC provides detailed information about the SRv6 transport network to UTNC(SMF) through the "Utnc TransportNetwork create, SR info" message. This information includes IP addresses, interface information, and neighbor node addresses of each SR node, along with per-link metric information such as source address, destination address, delay time, and bandwidth.

UTNC configures SR topology based on the received information (602). Through the "SR topology configuration" process, UTNC configures a single-domain perspective network topology. In this process, it comprehensively considers connectivity between nodes, link states, and metric information to understand the overall network structure.

Based on the configured topology, UTNC calculates the optimal path and generates a SID list (603). In the "Optimal path calculation" process, it calculates the optimal path between source-destination node pairs. This process can utilize various approaches including traditional shortest path algorithms like Dijkstra, as well as AI/ML-based prediction models. Based on the calculated optimal path, it generates SID lists according to service requirements.

The generated SID list is delivered to data plane nodes through SMF. UTNC delivers the downlink SID list to UPF through the N4 interface (604). UPF receives the SID information needed for downlink traffic processing through the "N4 interface request (DL SID information)" message.

UTNC delivers the uplink SID list to AMF through the N11 interface (605). Uplink path information is delivered to AMF through the "N11 interface request (UL SID information)" message.

AMF delivers the received uplink SID list to RAN through the N2 interface (606). RAN receives the SID information needed for uplink traffic processing through the "N2 interface request (UL SID information)" message.

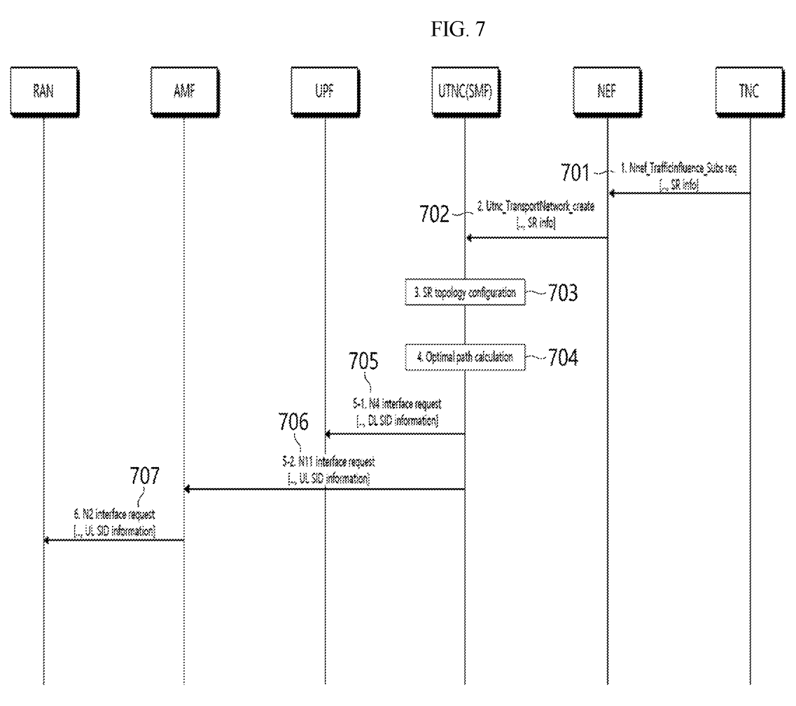

FIG. 7 illustrates a UTNC-based core network and untrusted SRv6 transport network interworking procedure according to an embodiment of the present disclosure. This procedure is an interworking method with untrusted TNC, performed through secured interworking via NEF according to 3GPP standards.

TNC delivers SR node and link information through NEF (701). Untrusted TNC delivers SRv6 transport network information to NEF through the "Nnef_TrafficInfluence Subscribe req - SR info" message. In this process, appropriate authentication is performed as defined by 3GPP.

NEF delivers the received SR information to UTNC (702). NEF delivers the "Utnc TransportNetwork create - SR info" message to UTNC(SMF) through the extended Traffic Influence API. The present disclosure defines extended parameters in this API to enable delivery of SR node and link information.

UTNC configures SR topology based on the received information (703). Through the "SR topology configuration" process, UTNC configures a single-domain perspective network topology. In this process, it comprehensively considers connectivity between nodes, link states, and metric information to understand the overall network structure.

Based on the configured topology, UTNC calculates the optimal path and generates a SID list (704). In the "Optimal path calculation" process, it calculates the optimal path between source-destination node pairs. This process can utilize various approaches including traditional shortest path algorithms like Dijkstra, as well as AI/ML-based prediction models.

The generated SID list is delivered to data plane nodes through SMF. UTNC delivers the downlink SID list to UPF through the N4 interface (705). UPF receives the SID information needed for downlink traffic processing through the "N4 interface request (DL SID information)" message.

UTNC delivers the uplink SID list to AMF through the N11 interface (706). Uplink path information is delivered to AMF through the "N11 interface request (UL SID information)" message.

AMF delivers the received uplink SID list to RAN through the N2 interface (707). RAN receives the SID information needed for uplink traffic processing through the "N2 interface request (UL SID information)" message.

The main difference between untrusted TNC and trusted TNC interworking procedures is the method of receiving SR information from TNC. For untrusted TNC, information is exchanged through NEF, while for trusted TNC, information is exchanged through direct interworking with UTNC. However, the processes of SR topology configuration, path calculation, and SID list delivery to data plane nodes proceed identically in both procedures.

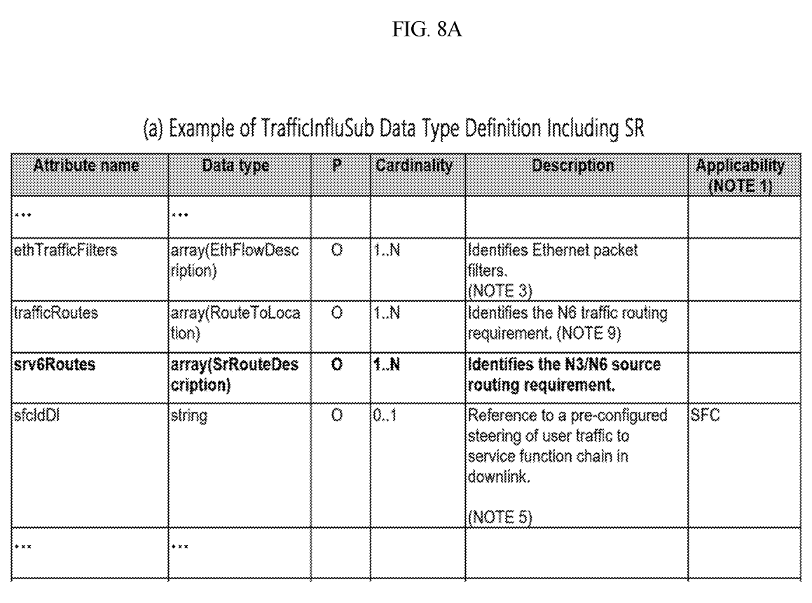

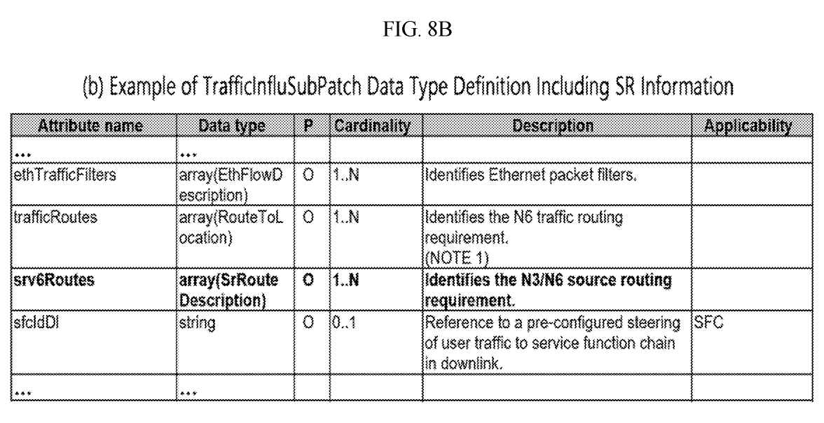

FIG. 8a illustrates an example of interface extension for adding SR information to data types used in NEF's Traffic Influence API according to an embodiment of the present disclosure. Specifically, it shows an example of TrafficInfluSub data type definition including SR information.

The existing TrafficInfluence API included attributes for defining N6 section traffic routing requirements, but the present disclosure additionally requires SR-related attributes for defining N3/N6 section source routing requirements.

As shown in FIG. 8a, existing attributes include ethTrafficFilters defined as array(EthFlowDescription) type identifying Ethernet packet filters, and trafficRoutes defined as array(RouteToLocation) type identifying N6 traffic routing requirements.

The present disclosure adds a new attribute srv6Routes. However, this is merely one example, and the same functionality can be implemented through various data structures and formats. This attribute is defined as array(SrRouteDescription) type and identifies N3/N6 source routing requirements with the description "Identifies the N3/N6 source routing requirement". This attribute is added as an optional attribute with cardinality of 1..N, allowing it to contain one or more SR path information.

Through this interface extension, untrusted TNC can deliver SR-related information to UTNC through NEF's TrafficInfluence API. This maintains the existing NEF TrafficInfluence API structure while accommodating essential SR information needed for interworking with SRv6-based transport networks.

FIG. 8b illustrates an example of TrafficInfluSubPatch data type definition including SR information according to an embodiment of the present disclosure. TrafficInfluSubPatch is a data structure used when selectively modifying only some parameters of an existing traffic influence subscription, included in the request body of HTTP PATCH messages.

Like TrafficInfluSub in FIG. 8a, TrafficInfluSubPatch also requires extension for delivering SR information. Existing attributes include ethTrafficFilters defined as array(EthFlowDescription) type identifying Ethernet packet filters, and trafficRoutes defined as array(RouteToLocation) type identifying N6 traffic routing requirements.

The present disclosure also adds the new attribute srv6Routes to TrafficInfluSubPatch. However, this is merely one example, and the same functionality can be implemented through various data structures and formats. This attribute is defined as array(SrRouteDescription) type and identifies N3/N6 source routing requirements with the description "Identifies the N3/N6 source routing requirement". This attribute is added as an optional attribute with cardinality of 1..N, allowing it to contain one or more SR path information.

The sfcIdDl attribute represents a pre-configured reference for steering user traffic to a service function chain in the downlink and supports Service Function Chaining (SFC) related functions.

Through this extension of TrafficInfluSubPatch, untrusted TNC can selectively update only SR-related information in existing traffic influence subscriptions, enabling flexible SR information management in dynamic network environments. In particular, attributes that can deliver N3/N6 section source routing requirements must be included, enabling effective sharing of transport network detailed routing information with the core network.

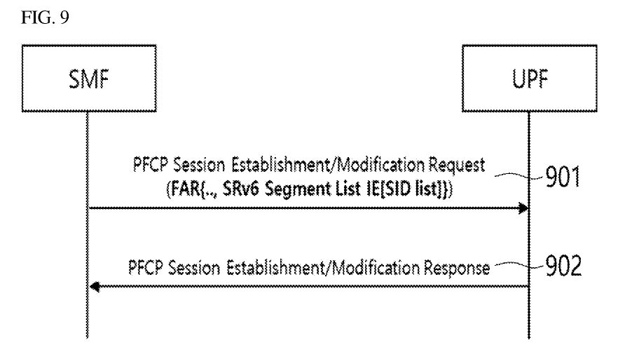

FIG. 9 illustrates SID information delivery through the N4 interface between SMF and UPF according to an embodiment of the present disclosure. To deliver the SID list generated by UTNC to UPF, Packet Forwarding Control Protocol through the N4 interface between SMF and UPF is utilized.

When the SID list generated by UTNC is delivered for the first time, SMF delivers it to UPF through a PFCP Session Establishment Request message (901). At this time, the SID list is delivered included in Forwarding Action Rules (FAR), specifically with the SRv6 segment list included in the form "FAR[...SRv6 Segment List (E[SID list])]". Through this, UPF receives the segment routing information needed for downlink traffic processing.

When needing to deliver or update a SID list for an already established PDU session, SMF uses a PFCP Session Modification Request message. Through this, existing forwarding action rules can be updated or new forwarding action rules can be added to deliver the SID list.

UPF responds to the received request with PFCP Session Establishment Response or PFCP Session Modification Response (902). Subsequently, UPF performs source routing for user traffic according to the received SID list.

Through these Packet Forwarding Control Protocol session management procedures, UTNC can dynamically deliver and manage necessary SR information to UPF via SMF. The SRv6 segment list included in the forwarding action rules provides important information that enables UPF to insert and process appropriate segment routing headers during packet forwarding.

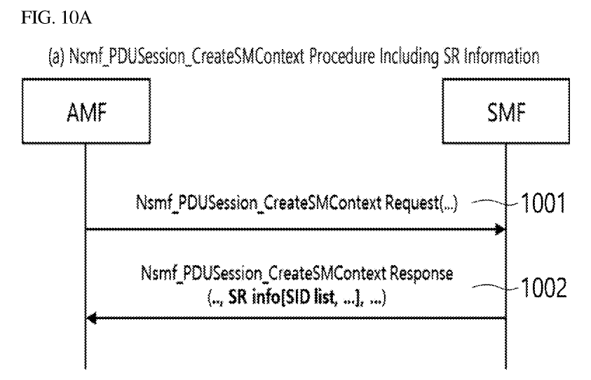

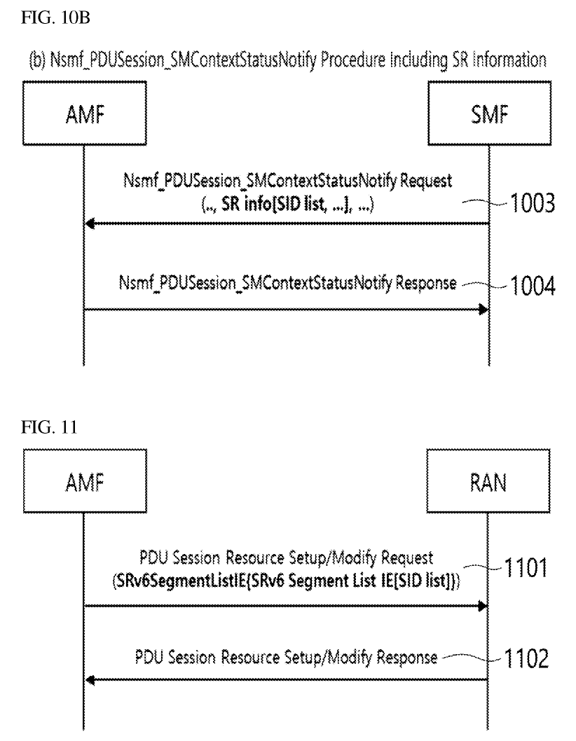

FIG. 10a illustrates SID information delivery through the N11 interface between SMF and AMF according to an embodiment of the present disclosure. Specifically, it shows the Nsmf_PDUSession_CreateSMContext procedure including SR information.

To deliver the SID list generated by UTNC to RAN, the SID list must first be delivered through the N11 interface between SMF and AMF. SMF communicates with AMF through PDU session services, and when the SID list is already prepared during initial PDU session establishment, it delivers the SID list through the response of the session creation service operation.

AMF sends an Nsmf_PDUSession_CreateSMContext Request message to SMF for PDU session establishment (1001). This request includes basic information needed for session establishment.

SMF processes the request and responds with an Nsmf_PDUSession_CreateSMContext Response message including the SID list received from UTNC (1002). This response message includes segment routing information in the form "SR info[SID list, ...]". Through this, AMF receives the uplink SID list to be delivered to RAN.

FIG. 10b illustrates the Nsmf_PDUSession_SMContextStatusNotify procedure including SR information according to an embodiment of the present disclosure. This is a procedure used when initially delivering a SID list or updating an existing SID list when a PDU session is already established.

When a new SID list is generated from UTNC or an existing SID list is changed while a PDU session is already established, SMF must actively notify AMF of these changes. For this, SMF utilizes the notification service.

SMF delivers SR information changes to AMF through an Nsmf_PDUSession_SMContextStatusNotify Request message (1003). This notification message includes updated segment routing information in the form "SR info[SID list, ...]". Through this, SMF can actively notify AMF of SR-related information changes.

AMF responds to the received notification with an Nsmf_PDUSession_SMContextStatusNotify Response message (1004). Through this, AMF confirms to SMF that it has received the changed SID information.

Through this N11 interface notification service, SMF can dynamically deliver real-time changing SR information to AMF, enabling flexible segment routing management according to network situation changes. AMF will deliver the received updated SID list to RAN through the N2 interface.

Through this N11 interface session creation service operation, SMF can effectively deliver SR-related information along with session management information to AMF, and AMF can provide appropriate segment routing information to RAN based on this.

FIG. 11 illustrates SID information delivery from AMF to RAN through the N2 interface according to an embodiment of the present disclosure. To deliver the SID list received by AMF from SMF to RAN, NG Application Protocol of the N2 interface is utilized.

During initial PDU session establishment, AMF delivers the SID list through a PDU Session Resource Setup Request message (1101). When needing to deliver or update a SID list for an already established PDU session, a PDU Session Resource Modify Request message is used. This request message includes SRv6 segment list information elements in the form "SRv6SegmentListIE[SRv6 Segment List IE[SID list]]". For this, the PDU Session Resource Setup Request Transfer IE and PDU Session Resource Modify Request Transfer IE of NG Application Protocol messages are extended to include the SID list.

RAN responds to the received request with PDU Session Resource Setup Response or PDU Session Resource Modify Response (1102). Through this, RAN informs AMF that it has successfully received the SID information.

RAN performs source routing for uplink traffic received from user equipment according to the received SID list. RAN inserts appropriate segment routing headers in uplink packets and forwards packets to the transport network according to the provided SID list.

Through this extension of NG Application Protocol, AMF can dynamically deliver and manage necessary SR information to RAN, enabling segment routing-based path control for uplink traffic.

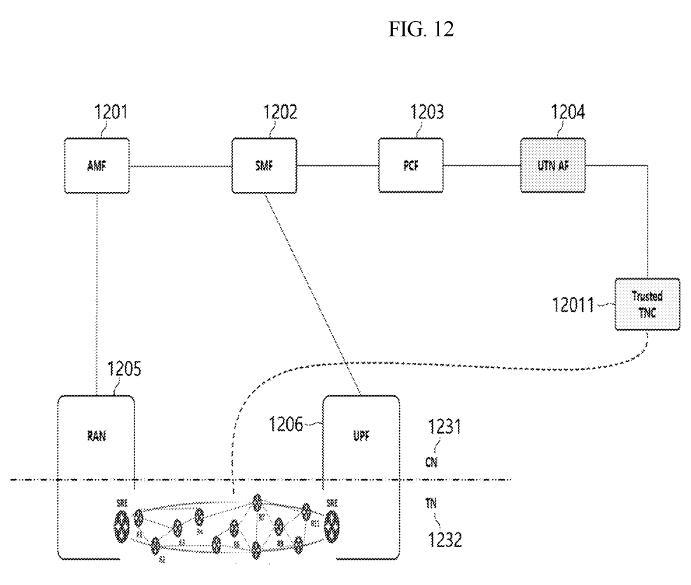

FIG. 12 illustrates a core network and trusted SRv6 transport network interworking structure through UTN AF according to an embodiment of the present disclosure. Unlike the interworking method through UTNC in FIG. 3, this method provides interworking functions with TNC while performing functions as an independent application function.

UTN AF (1204) of the core network is an application function of the core network control plane responsible for interworking functions with external TNC. UTN AF (1204) handles network interworking with TNC responsible for controlling SRv6-based transport networks, and TNC (1211) manages SR node information for SR nodes in the SRv6-based transport network and handles interworking with UTN AF (1204).

In FIG. 12, TNC (1211) is a trusted TNC, typically when the operators of the core network and transport network are the same. As the communication operator also operates the transport network, TNC (1211) is defined as a trusted TNC enabling direct interworking with UTN AF (1204). The interface used can basically be defined as a RESTful API-based interface, similar to FIG. 3, or commonly used interfaces such as IETF YANG model-based Netconf/Restconf can be defined and used.

In the core network (1231) area, AMF (1201), SMF (1202), PCF (1203), UTN AF (1204), RAN (1205), and UPF (1206) are located. In the transport network (1232) area, trusted TNC (1211) is located to manage the SRv6-based transport network. Within transport network (1232), SR nodes such as R1, R2, R3, R4, R6, R7, R9, and R11 are deployed and interconnected to form various SR paths.

The interworking between UTN AF (1204) and trusted TNC (1211) is shown with a dotted line, indicating direct interworking. This structure can maintain consistency with the core network's policy-based control system by utilizing the existing 5G policy control structure to deliver SR information.

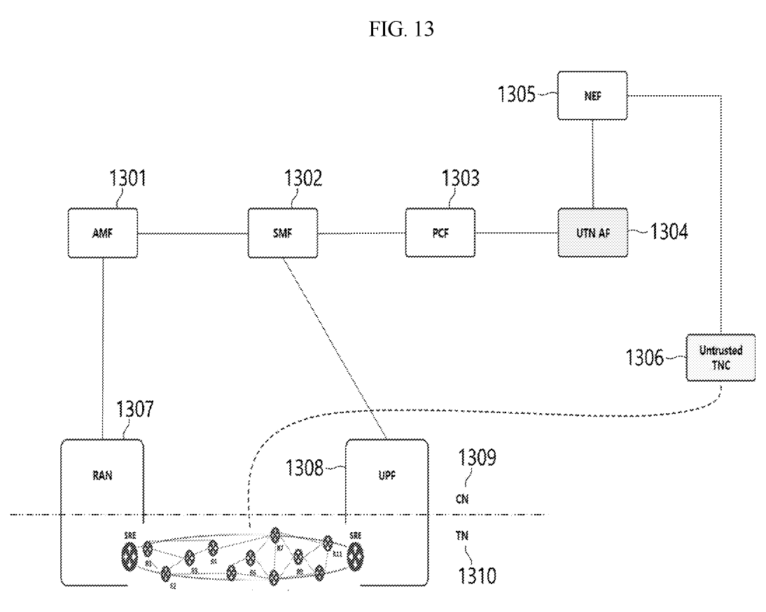

FIG. 13 illustrates a core network and 3rd party operator's SRv6-based transport network interworking structure through UTN AF according to an embodiment of the present disclosure. As in FIG. 4, UTN AF (1304) of the core network is an application function of the core network control plane responsible for interworking functions with external TNC.

TNC (1306) is an untrusted TNC, which can be an SRv6 transport network operated by a third-party operator different from the communication network operator. As defined by 3GPP, it can access the core network through NEF (1305), and TNC (1306) interworks with UTN AF (1304) through NEF (1305).

TNC (1306) extends the Traffic Influence API interface currently defined in 3GPP through the NEF (1305) N33 interface to deliver SR node information as parameters, and the received SR node information is delivered to internal UTN AF (1304).

In the core network (1309) area, AMF (1301), SMF (1302), PCF (1303), UTN AF (1304), NEF (1305), RAN (1307), and UPF (1308) are located. In the transport network (1310) area, untrusted TNC (1306) is located to manage the SRv6-based transport network operated by a 3rd party operator.

Within transport network (1310), SR nodes such as R1, R2, R3, R4, R6, R7, R9, and R11 are deployed and interconnected to form various SR paths. The interworking between NEF (1305) and untrusted TNC (1306) is shown with a dotted line, indicating a security-enhanced 3GPP standard-based interworking method.

This structure enables efficient network resource utilization and service optimization even when core network and transport network operators are different, and the UTN AF-based interworking method can maintain consistency with the core network's policy-based control system by utilizing the existing 5G policy control structure to deliver SR information.

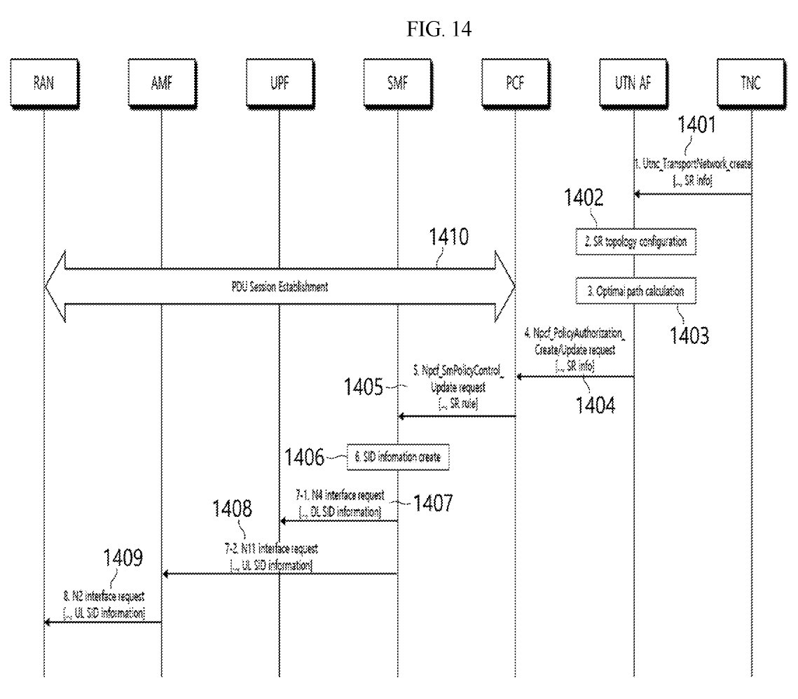

FIG. 14 illustrates a core network and trusted SRv6 transport network interworking procedure through UTN AF according to an embodiment of the present disclosure. This procedure is an interworking method with trusted TNC, performed through direct information exchange between TNC and UTN AF.

TNC directly delivers SR node and link information to UTN AF (1401). TNC provides detailed information about the SRv6 transport network to UTN AF through the "Utnc TransportNetwork create - SR info" message. This information includes IP addresses, interface information, and neighbor node addresses of each SR node, along with per-link metric information.

UTN AF configures SR topology based on the received information (1402). Through the "SR topology configuration" process, UTN AF configures a single-domain perspective network topology. In this process, it comprehensively considers connectivity between nodes, link states, and metric information to understand the overall network structure.

Based on the configured topology, UTN AF calculates the optimal path and generates a SID list (1403). In the "Optimal path calculation" process, it calculates the optimal path between source-destination node pairs. This process can utilize various approaches including traditional shortest path algorithms like Dijkstra, as well as AI/ML-based prediction models.

UTN AF then delivers SR information to PCF through the Policy Authorization service operation (1404). UTN AF delivers routing requirements including the SID list to PCF through the "Npcf_PolicyAuthorization Create/Update request - SR rules" message.

When the PDU session establishment process proceeds (1410), PCF converts the received SR information into policy rules and delivers them to SMF (1405). Policy-based SR rules are delivered to SMF through the "Npcf_SmPolicyControl Update request - SR rules" message.

SID information is created in SMF (1406). Policy-based SR rules are processed and SID information is prepared through the "SID information create" process.

SMF performs PDU session control procedures including SID information according to policy rules. SMF delivers the downlink SID list to UPF through the N4 interface (1407). UPF receives the SID information needed for downlink traffic processing through the "N4 interface request (DL SID information)" message.

SMF delivers the uplink SID list to AMF through the N11 interface (1408). Uplink path information is delivered to AMF through the "N11 interface request (UL SID information)" message.

AMF delivers the received uplink SID list to RAN through the N2 interface (1409). RAN receives the SID information needed for uplink traffic processing through the "N2 interface request (UL SID information)" message.

This UTN AF-based interworking method can maintain consistency with the core network's policy-based control system by utilizing the existing 5G policy control structure to deliver SR information.

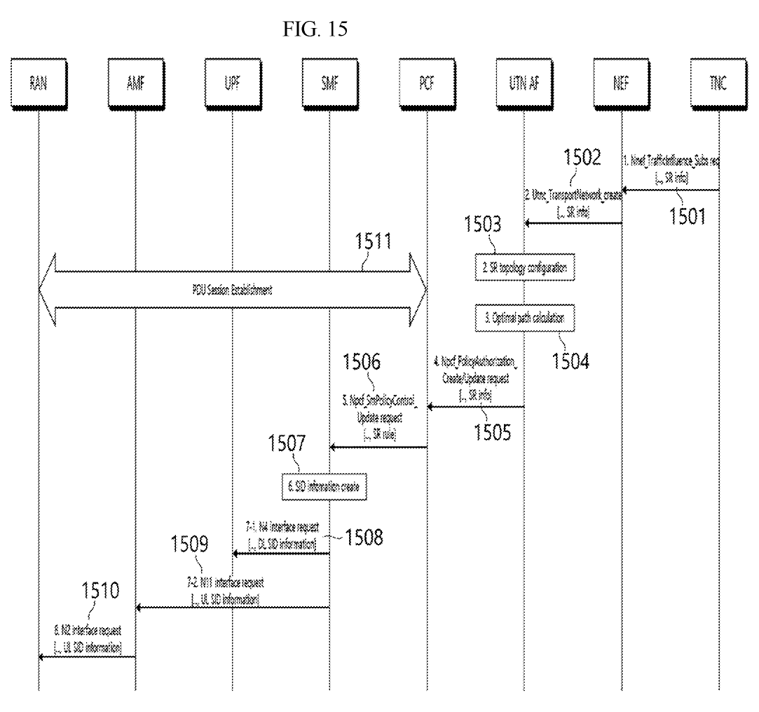

FIG. 15 illustrates a core network and untrusted SRv6 transport network interworking procedure through UTN AF according to an embodiment of the present disclosure. This procedure is an interworking method with untrusted TNC, performed through secured interworking via NEF according to 3GPP standards.

TNC delivers SR node and link information through NEF (1501). Untrusted TNC delivers SRv6 transport network information to NEF through the "Nnef_TrafficInfluence Subscribe req - SR info" message. In this process, appropriate authentication is performed as defined by 3GPP.

NEF delivers the received SR information to UTN AF (1502). NEF delivers the "Utnc TransportNetwork create - SR info" message to UTN AF through the extended Traffic Influence API. The present disclosure defines extended parameters in this API to enable delivery of SR node and link information.

UTN AF configures SR topology based on the received information (1503). Through the "SR topology configuration" process, UTN AF configures a single-domain perspective network topology. In this process, it comprehensively considers connectivity between nodes, link states, and metric information to understand the overall network structure.

Based on the configured topology, UTN AF calculates the optimal path and generates a SID list (1504). In the "Optimal path calculation" process, it calculates the optimal path between source-destination node pairs. This process can utilize various approaches including traditional shortest path algorithms like Dijkstra, as well as AI/ML-based prediction models.

UTN AF then delivers SR information to PCF through the Policy Authorization service operation (1505). UTN AF delivers routing requirements including the SID list to PCF through the "Npcf_PolicyAuthorization Create/Update request - SR rules" message.

When the PDU session establishment process proceeds (1511), PCF converts the received SR information into policy rules and delivers them to SMF (1506). Policy-based SR rules are delivered to SMF through the "Npcf_SmPolicyControl Update request - SR rules" message.

SID information is created in SMF (1507). Policy-based SR rules are processed and SID information is prepared through the "SID information create" process.

SMF performs PDU session control procedures including SID information according to policy rules. SMF delivers the downlink SID list to UPF through the N4 interface (1508). UPF receives the SID information needed for downlink traffic processing through the "N4 interface request (DL SID information)" message.

SMF delivers the uplink SID list to AMF through the N11 interface (1509). Uplink path information is delivered to AMF through the "N11 interface request (UL SID information)" message.

AMF delivers the received uplink SID list to RAN through the N2 interface (1510). RAN receives the SID information needed for uplink traffic processing through the "N2 interface request (UL SID information)" message.

The main difference between untrusted TNC and trusted TNC interworking procedures is the method of receiving SR information from TNC. For untrusted TNC, information is exchanged through NEF, while for trusted TNC, information is exchanged through direct interworking with UTN AF. However, the processes of SR topology configuration, path calculation, and policy-based SID list delivery proceed identically in both procedures.

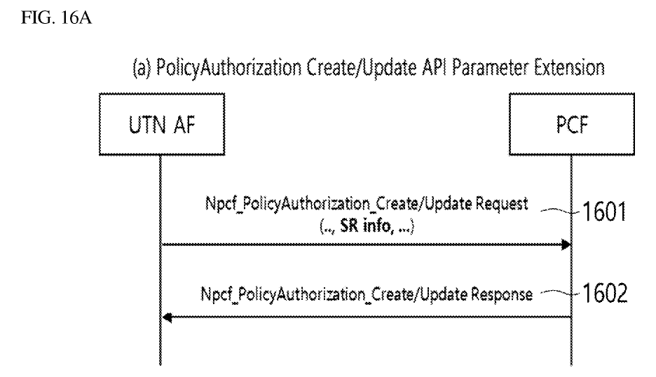

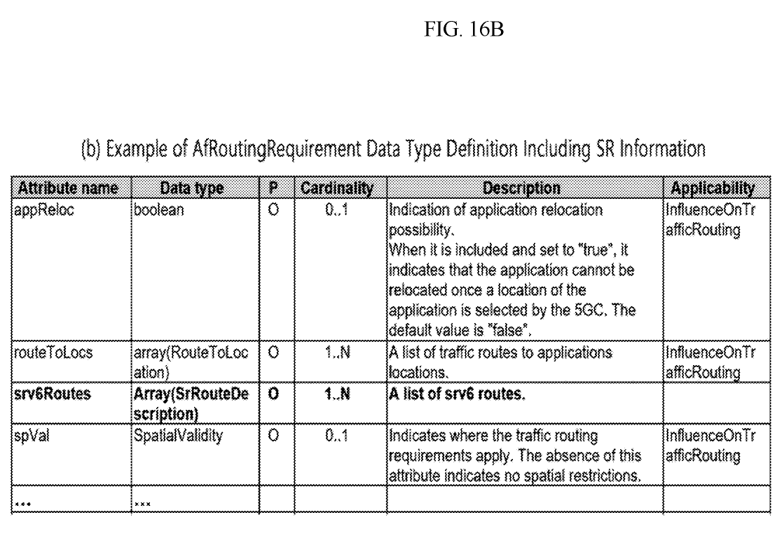

FIG. 16a illustrates PCF PolicyAuthorization API interface extension according to an embodiment of the present disclosure. Specifically, it shows PolicyAuthorization Create/Update API parameter extension.

UTN AF uses the Policy Authorization API to deliver the SID list generated based on SR node and link information received from TNC to PCF. UTN AF delivers SR information to PCF through the Npcf_PolicyAuthorization_Create/Update Request message (1602). This request message includes an "SR info" parameter, which is the extended part in the present disclosure.

The PolicyAuthorization API used in PCF's N5 interface delivers application session context information through the AppSessionContextReqData type. In this data type, the afRoutReq attribute consists of the AfRoutingRequirement type that defines requirements for influencing traffic routing.

The present disclosure adds a new attribute 'srv6Routes' to the existing AfRoutingRequirement type for delivering SR path information. However, this is merely one example, and the same functionality can be implemented through various data structures and formats. This is defined as Array(SrRouteDescription) type to include SRv6 path information. In particular, the data structure of this attribute has the same structure as the RouteToLocation type used in NEF's TrafficInfluence API, ensuring consistent delivery of SR path information.

PCF responds with an Npcf _ PolicyAuthorization _ Create / Update Response message after processing the received request (1601). Through this, UTN AF can confirm that SR information has been successfully delivered to PCF.

Through this extension of the PolicyAuthorization API, UTN AF can deliver SR path information to PCF, and PCF can convert it into policy rules and deliver them to SMF. This enables integration with SR-based transport networks by utilizing the existing policy control framework.

FIG. 16b illustrates an example of AfRoutingRequirement data type definition including SR information according to an embodiment of the present disclosure. This shows the extension of data structures used in PCF's PolicyAuthorization API.

The existing AfRoutingRequirement data type has several attributes defined. The appReloc attribute is a boolean type indicating the possibility of application relocation and is an optional attribute with cardinality of 0..1. If this attribute is included and set to "true", it indicates that the application cannot be relocated at a location selected by 5GC.

The routeToLocs attribute is defined as array(RouteToLocation) type and represents a list of traffic routes to application locations. This is an optional attribute with cardinality of 1..N, allowing it to contain one or more route information.

The newly added srv6Routes attribute in the present disclosure is defined as Array(SrRouteDescription) type and represents "A list of srv6 routes" indicating a list of SRv6 routes. However, this is merely one example, and the same functionality can be implemented through various data structures and formats. This attribute is added as an optional attribute with cardinality of 1..N, allowing it to contain one or more SRv6 path information. This enables defining N3/N6 section source routing requirements.

The spVal attribute is defined as SpatialValidity type and indicates the location where traffic routing requirements are applied. The absence of this attribute means there are no spatial restrictions.

Through this extension of the AfRoutingRequirement data type, UTN AF can deliver SRv6-based segment routing information along with existing traffic routing information to PCF, enabling effective interworking between transport networks and core networks.

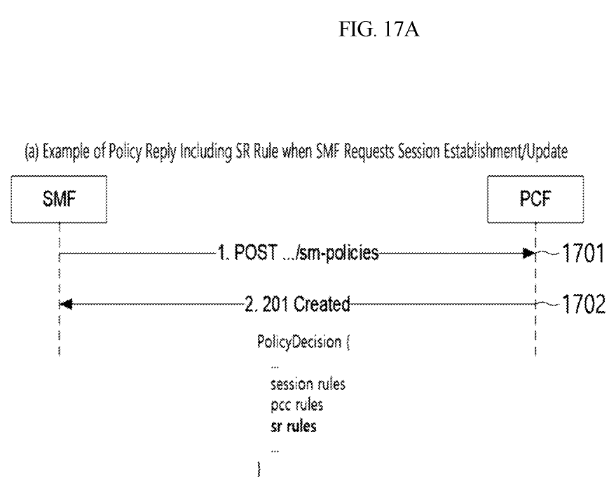

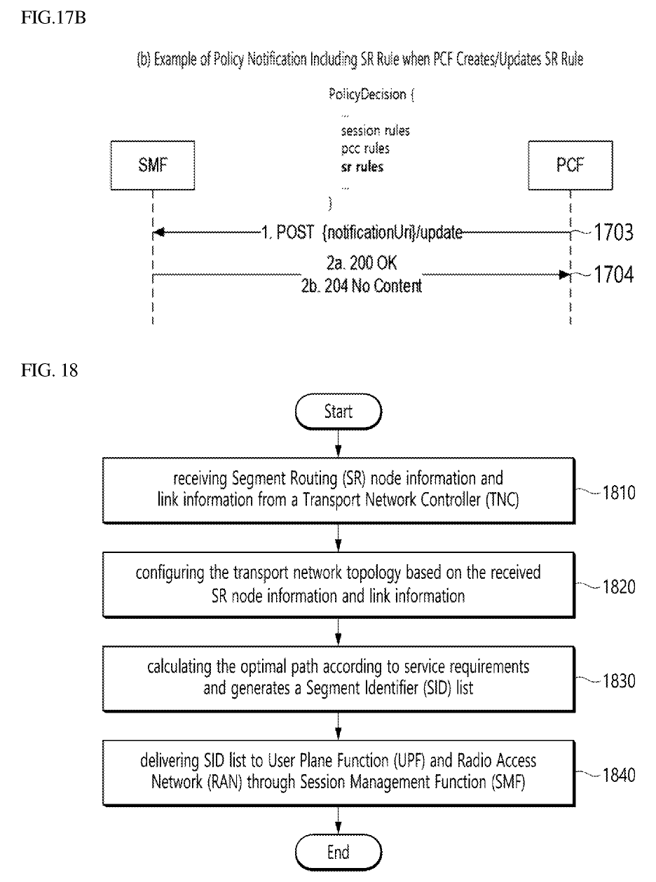

FIG. 17a illustrates the PCF SmPolicyControl API interface according to an embodiment of the present disclosure. Specifically, it shows an example of policy reply including SR rule when SMF requests session establishment/update.

Policy rules are delivered through the session management policy control service on the N7 interface between PCF and SMF, and the present disclosure extends PolicyDecision data to include SR rules.

SR rule delivery can be done in two ways. FIG. 17a shows the method by SMF request. This is a procedure used when SMF requests the session management policy control creation service operation for PDU session creation or requests the session management policy control update service operation for session modification.

SMF requests policy decision from PCF through the "POST .../sm-policies" message (1702). This request occurs during the PDU session establishment process, and SMF provides PCF with information such as session information, QoS requirements, and user identifiers.

PCF processes this request and replies with policy decision through a "201 Created" response (1701). The PolicyDecision data in this response includes newly added sr rules along with existing session rules and pcc rules. PCF delivers the currently stored SR rule included in the PolicyDecision data of the response.

The sr rules included in PolicyDecision are policy rules generated by PCF based on SR path information received from UTN AF. Through this, SMF receives segment routing information needed for interworking with SRv6-based transport networks and can control SR operations of data plane nodes based on this.

Through this SR rule delivery mechanism, PCF can manage and deliver SR information based on policies, and SMF can provide necessary segment routing information to UPF and RAN based on this.

FIG. 17b illustrates an example of policy notification including SR rule when PCF creates/updates SR rule according to an embodiment of the present disclosure. This shows the method by PCF's active notification.

When new SR rules are added to PCF or existing SR rules are changed while a PDU session is already established, PCF delivers updated PolicyDecision to SMF through the session management policy control update notification service operation.

PCF actively notifies SMF of updated policy information through the "POST (notificationUri)/update" message (1704). The PolicyDecision data in this notification message includes newly created or updated sr rules along with session rules and pcc rules.

This active notification occurs when new SR information is delivered from UTN AF to PCF or when existing SR rules need to be modified due to network situation changes. PCF enables dynamic segment routing management by delivering policy changes to SMF in real-time.

SMF confirms the received notification with a "200 OK" or "204 No Content" response (1703). Through this, SMF informs PCF that it has successfully received the updated SR rule.

SMF can apply the real-time changed SR rule and deliver updated segment routing information to UPF and RAN. Through this mechanism, dynamic SR policy control according to network situation changes or new service requirements becomes possible.

Through the two SR rule delivery methods (SMF request-based and PCF active notification), flexible and efficient segment routing information management is possible in various scenarios.

FIG. 18 illustrates a flowchart of a UTNC-based method according to an embodiment of the present disclosure. This shows step-by-step the operation method of UTNC for integrating a core network and SRv6-based transport network in a wireless communication system.

UTNC receives Segment Routing (SR) node information and link information from a Transport Network Controller (TNC) (1810). This process can be performed in two ways depending on the type of TNC. When TNC is a trusted TNC with reliability, UTNC directly interworks with TNC to receive SR node information and link information. This typically applies when the operators of the core network and transport network are the same, and complex security measures are not necessary. On the other hand, when TNC is an untrusted TNC without reliability, UTNC receives SR node information and link information through Network Exposure Function (NEF). This is done after appropriate authentication as defined by 3GPP.

The received information includes detailed information such as IP addresses, interface information, and neighbor node addresses of each SR node, along with per-link metric information such as source address, destination address, delay time, and bandwidth. When interworking with untrusted TNC, SR node information and link information are delivered by extending NEF's Traffic Influence Application Programming Interface (API).

UTNC configures the transport network topology based on the received SR node information and link information (1820). In this process, it comprehensively considers connectivity between nodes, link states, and metric information to understand the overall network structure. UTNC enables integrated management of core networks and transport networks by configuring a single-domain perspective network topology.

Based on the configured topology, UTNC calculates the optimal path according to service requirements and generates a Segment Identifier (SID) list (1830). In this process, it applies shortest path algorithms between source-destination node pairs in the configured topology and determines the optimal path considering Quality of Service (QoS) parameters according to service requirements. Path calculation can utilize various approaches including traditional shortest path algorithms like Dijkstra, as well as AI/ML-based prediction models.

The generated SID list is delivered to User Plane Function (UPF) and Radio Access Network (RAN) through Session Management Function (SMF) (1840). In this process, SMF delivers the downlink SID list to UPF through the N4 interface, SMF delivers the uplink SID list to Access and Mobility Management Function (AMF) through the N11 interface, and AMF delivers the uplink SID list to RAN through the N2 interface. Each data plane node (RAN, UPF) performs source routing for user traffic according to the received SID list.

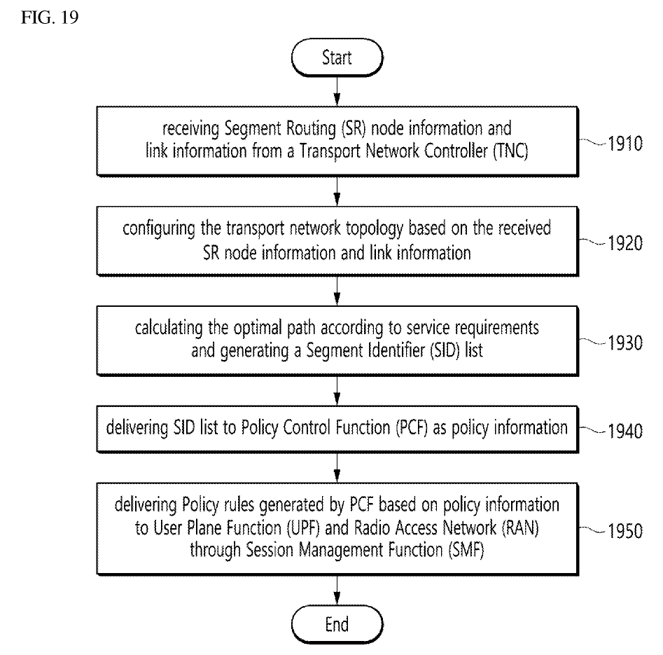

FIG. 19 illustrates a flowchart of a UTN AF-based method according to an embodiment of the present disclosure. This shows step-by-step the operation method of UTN Application Function (UTN AF) for integrating a core network and SRv6-based transport network in a wireless communication system.

UTN AF receives Segment Routing (SR) node information and link information from a Transport Network Controller (TNC) (1910). This process can be performed in two ways depending on TNC's reliability. When TNC is a trusted TNC, UTN AF directly interworks with TNC to receive SR node information and link information. This typically applies when the operators of the core network and transport network are the same, where the communication operator also operates the transport network, so TNC is defined as a trusted TNC enabling direct interworking with UTN AF. The interface used can basically be defined as a RESTful API-based interface, or commonly used interfaces such as IETF YANG model-based Netconf/Restconf can be defined and used.

On the other hand, when TNC is an untrusted TNC, UTN AF receives SR node information and link information through Network Exposure Function (NEF). This is the case of an SRv6 transport network operated by a third-party operator different from the communication network operator, and as defined by 3GPP, access to the core network is possible through NEF. When interworking with untrusted TNC, SR node information and link information are delivered by extending NEF's Traffic Influence API. TNC extends the Traffic Influence API interface currently defined in 3GPP through the NEF N33 interface to deliver SR node information as parameters, and the received SR node information is delivered to internal UTN AF.

UTN AF configures the transport network topology based on the received SR node information and link information (1920). In this process, it comprehensively considers connectivity between nodes, link states, and metric information to understand the overall network structure. UTN AF enables integrated management of core networks and transport networks by configuring a single-domain perspective network topology.

Based on the configured topology, UTN AF calculates the optimal path according to service requirements and generates a Segment Identifier (SID) list (1930). In this process, it calculates the optimal path between source-destination node pairs and can utilize various approaches including traditional shortest path algorithms like Dijkstra, as well as AI/ML-based prediction models. Based on the calculated optimal path, it generates SID lists according to service requirements.

The generated SID list is delivered to Policy Control Function (PCF) as policy information (1940). UTN AF delivers routing requirements including the SID list to PCF through the Policy Authorization API, and PCF converts the routing requirements into policy rules and delivers them to SMF. In this process, UTN AF delivers SR information to PCF through the Policy Authorization service operation, and the PolicyAuthorization API used in PCF's N5 interface delivers application session context information through the AppSessionContextReqData type. The present disclosure adds a new attribute 'srv6Routes' to the existing AfRoutingRequirement type to include SRv6 path information for delivering SR path information. However, this is merely one example, and the same functionality can be implemented through various data structures and formats.

Policy rules generated by PCF based on policy information are delivered to User Plane Function (UPF) and Radio Access Network (RAN) through Session Management Function (SMF) (1950). PCF converts the received SR information into policy rules and delivers them to SMF, which is done in two ways. In the SMF request-based method, when SMF requests for PDU session creation or modification, PCF delivers the currently stored SR rule included in the PolicyDecision data of the response. In the PCF active notification method, when new SR rules are added to PCF or existing SR rules are changed while a PDU session is already established, PCF delivers updated PolicyDecision to SMF through the session management policy control update notification service operation.

SMF performs PDU session control procedures including SID information according to the received policy rules, delivers the downlink SID list to UPF through the N4 interface, delivers the uplink SID list to Access and Mobility Management Function (AMF) through the N11 interface, and AMF delivers the uplink SID list to RAN through the N2 interface. This UTN AF-based interworking method can maintain consistency with the core network's policy-based control system by utilizing the existing 5G policy control structure to deliver SR information.

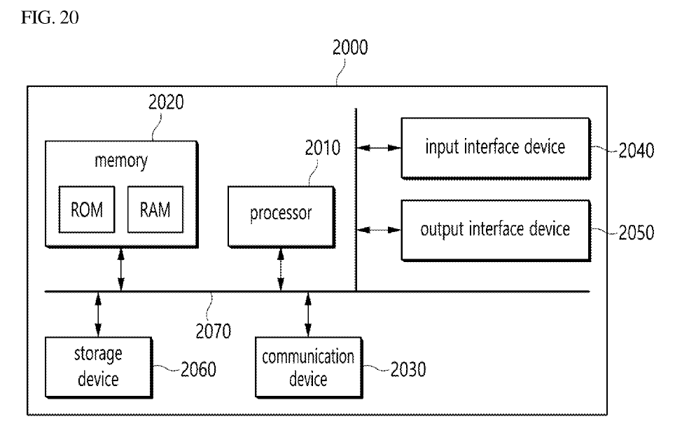

FIG. 20 illustrates a device configuration according to an embodiment of the present disclosure. Referring to FIG. 20, the device (2000) of the present disclosure may include at least one processor (2010), memory (2020), and a communication device (2030) connected to a network for communication. Additionally, the device (2000) of the present disclosure may further include an input interface device (2040), output interface device (2050), storage device (2060), etc. Each component included in the device (2000) of the present disclosure can be connected by a bus (2070) to communicate with each other.

However, each component included in the device (2000) of the present disclosure may be connected through individual interfaces or individual buses centered on the processor (2010) rather than the common bus (2070). For example, the processor (2010) may be connected to at least one of the memory (2020), communication device (2030), input interface device (2040), output interface device (2050), and storage device (2060) through dedicated interfaces.

The processor (2010) can execute program commands stored in at least one of the memory (2020) and storage device (2060). The processor (2010) may refer to a central processing unit (CPU), graphics processing unit (GPU), or a dedicated processor on which methods according to embodiments of the present disclosure are performed.

In the present disclosure, the processor (2010) may be configured to perform functions of UTNC or UTN AF. When the processor (2010) operates as UTNC, it is configured to receive SR node information and link information from TNC, configure a transport network topology based on the received SR node information and link information, calculate an optimal path according to service requirements based on the configured topology to generate a SID list, and deliver the generated SID list to UPF and RAN through SMF.

When the processor (2010) operates as UTN AF, it is configured to receive SR node information and link information from TNC, configure a transport network topology based on the received SR node information and link information, calculate an optimal path according to service requirements based on the configured topology to generate a SID list, deliver the generated SID list to PCF as policy information, and deliver policy rules generated by PCF based on the policy information to UPF and RAN through SMF.

Each of the memory (2020) and storage device (2060) may consist of at least one of volatile storage media and non-volatile storage media. For example, the memory (2020) may consist of at least one of read only memory (ROM) and random access memory (RAM).

The communication device (2030) handles communication with other network functions, particularly providing interfaces with TNC, NEF, PCF, SMF, etc. Through this, the device (2000) of the present disclosure can perform effective integration between core networks and SRv6-based transport networks.

Methods according to embodiments described in the claims or specification of the present disclosure may be implemented in the form of hardware, software, or a combination of hardware and software.

When implemented in software, a computer-readable storage medium storing one or more programs (software modules) may be provided. One or more programs stored in the computer-readable storage medium are configured for execution by one or more processors in an electronic device. One or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage, or magnetic cassette. Alternatively, they may be stored in memory configured as a combination of some or all of these. Also, multiple configuration memories may be included.

Furthermore, programs may be stored in attachable storage devices that can be accessed through communication networks such as the Internet, Intranet, local area network (LAN), wide area network (WAN), or storage area network (SAN), or a combination thereof. Such storage devices may connect to devices performing embodiments of the present disclosure through external ports. Additionally, separate storage devices on communication networks may connect to devices performing embodiments of the present disclosure.

In the specific embodiments of the present disclosure described above, components included in the disclosure were expressed in singular or plural according to the presented specific embodiments. However, singular or plural expressions were selected appropriately for the presented situations for convenience of description, and the present disclosure is not limited to singular or plural components, and even components expressed in plural may be configured in singular, or components expressed in singular may be configured in plural.

While specific embodiments have been described in the detailed description of the present disclosure, various modifications are possible without departing from the scope of the present disclosure. Therefore, the scope of the present disclosure should not be limited to the described embodiments but should be determined by the claims below as well as equivalents to these claims.

What is claimed is:

1. A method of operating a Unified Transport Network Controller (UTNC) for integrating a core network and a Segment Routing IPv6 (SRv6) based transport network in a wireless communication system, the method comprising:
receiving Segment Routing (SR) node information and link information from a Transport Network Controller (TNC);
configuring a transport network topology based on the received SR node information and link information;
calculating an optimal path according to service requirements based on the configured topology to generate a Segment Identifier (SID) list; and
delivering the generated SID list to a User Plane Function (UPF) and a Radio Access Network (RAN) through a Session Management Function (SMF).

2. The method of claim 1, further comprising:
directly interworking with the TNC to receive the SR node information and link information when the TNC is a trusted TNC having reliability; and
receiving the SR node information and link information through a Network Exposure Function (NEF) when the TNC is an untrusted TNC not having reliability.

3. The method of claim 2, further comprising:
extending a Traffic Influence Application Programming Interface (API) of the NEF to deliver the SR node information and link information when interworking with the untrusted TNC.

4. The method of claim 1, wherein delivering the SID list comprises:
delivering a downlink SID list to the UPF through an N4 interface by the SMF;
delivering an uplink SID list to an Access and Mobility Management Function (AMF) through an N11 interface by the SMF; and
delivering the uplink SID list to the RAN through an N2 interface by the AMF.

5. The method of claim 1, wherein calculating the optimal path comprises:
applying a shortest path algorithm between source-destination node pairs in the configured topology; and
determining the optimal path considering Quality of Service (QoS) parameters according to the service requirements.

6. A method of operating a UTN Application Function (UTN AF) for integrating a core network and an SRv6 based transport network in a wireless communication system, the method comprising:
receiving Segment Routing (SR) node information and link information from a Transport Network Controller (TNC);
configuring a transport network topology based on the received SR node information and link information;
calculating an optimal path according to service requirements based on the configured topology to generate a Segment Identifier (SID) list;
delivering the generated SID list to a Policy Control Function (PCF) as policy information; and
delivering policy rules generated by the PCF based on the policy information to a User Plane Function (UPF) and a Radio Access Network (RAN) through a Session Management Function (SMF).

7. The method of claim 6, further comprising:
directly interworking with the TNC to receive the SR node information and link information when the TNC is a trusted TNC; and
receiving the SR node information and link information through a Network Exposure Function (NEF) when the TNC is an untrusted TNC.

8. The method of claim 7, further comprising:
extending a Traffic Influence API of the NEF to deliver the SR node information and link information when interworking with the untrusted TNC.

9. The method of claim 6, wherein delivering as policy information comprises:
delivering routing requirements including the SID list to the PCF through a Policy Authorization API by the UTN AF; and
converting the routing requirements into policy rules and delivering to the SMF by the PCF.

10. The method of claim 6, wherein delivering the policy rules comprises:
delivering a downlink SID list to the UPF through an N4 interface by the SMF;
delivering an uplink SID list to an Access and Mobility Management Function (AMF) through an N11 interface by the SMF; and
delivering the uplink SID list to the RAN through an N2 interface by the AMF.

11. A Unified Transport Network Controller (UTNC) for integrating a core network and a Segment Routing IPv6 (SRv6) based transport network in a wireless communication system, comprising:
a transceiver; and
a processor operably connected to the transceiver,
wherein the processor is configured to:
receive Segment Routing (SR) node information and link information from a Transport Network Controller (TNC);
configure a transport network topology based on the received SR node information and link information;
calculate an optimal path according to service requirements based on the configured topology to generate a Segment Identifier (SID) list; and
deliver the generated SID list to a User Plane Function (UPF) and a Radio Access Network (RAN) through a Session Management Function (SMF).

12. The apparatus of claim 11, wherein the processor is configured to:
directly interwork with the TNC to receive the SR node information and link information when the TNC is a trusted TNC; and
receive the SR node information and link information through a Network Exposure Function (NEF) when the TNC is an untrusted TNC.

13. The apparatus of claim 12, wherein the processor is configured to:
receive the SR node information and link information by extending a Traffic Influence Application Programming Interface (API) of the NEF when interworking with the untrusted TNC.

14. The apparatus of claim 11, wherein the processor is configured to:
deliver the SID list such that the SMF delivers a downlink SID list to the UPF through an N4 interface, the SMF delivers an uplink SID list to an Access and Mobility Management Function (AMF) through an N11 interface, and the AMF delivers the uplink SID list to the RAN through an N2 interface.

15. The apparatus of claim 11, wherein the processor is configured to:
apply a shortest path algorithm between source-destination node pairs in the configured topology; and
determine the optimal path considering Quality of Service (QoS) parameters according to the service requirements.
